(19) United States
(12) Patent Application Publication
(10) Pub. No.: US 2013/0179343 A1
(43) Pub. Date: Jul. 11, 2013

(54) Method and Apparatus for Routing Data to and from an Automatic Teller Machine

(71) Applicant: Jerry Lynn McCarley, Spring, TX (US)

(72) Inventor: Jerry Lynn McCarley, Spring, TX (US)

(73) Assignee: USA PAYMENT SYSTEMS, Houston, TX (US)

(21) Appl. No.: 13/414,045

(22) Filed: Mar. 7, 2012

Related U.S. Application Data
(60) Provisional application No. 61/583,490, filed on Jan. 5, 2012.

(51) Int. Cl. G06Q 20/18

(52) U.S. Cl. 705/43

(57) ABSTRACT

A router in data communication with an Automated Teller Machine (ATM) is responsive to the state of the ATM. The router may connect the ATM system to a primary host or one or more alternative host systems. If a connection to the primary host cannot be made or an established connection to the primary host is lost, the router automatically establishes a connection to an alternative host. In one particular preferred embodiment, the router waits to switch the connection from an alternative host back to the primary host until the ATM has completed any pending transactions.

### CROSS-REFERENCE TO RELATED APPLICATIONS:

This application claims the benefit of U.S. Provisional Application No. 61/583,490, filed on Jan. 5, 2012.

### STATEMENT REGARDING FEDERALLY SPONSORED RESEARCH OR DEVELOPMENT: Not Applicable

### BACKGROUND OF THE INVENTION

1. Field of the Invention.

This invention relates to automated teller machines. More particularly, it relates to routers used to established and maintain telecommunication links with automated teller machines.

2. Description of the Related Art including information disclosed under 37 CFR 1.97 and 1.98.

An automated teller machine or automatic teller machine (ATM), also known as a cash machine is a computerized telecommunications device that provides the clients of a financial institution with access to financial transactions in a public space without the need for a cashier, human clerk or bank teller. ATMs are known by various other names including ATM machine, automated banking machine, and various regional variants derived from trademarks for ATM systems.

On most modern ATMs, the customer is identified by inserting a plastic ATM card with a magnetic stripe or a plastic smart card with a chip, that contains a unique card number and some security information such as an expiration date or card verification code. Authentication is typically provided by the customer entering a personal identification number (PIN).

Using an ATM, customers can access their bank accounts in order to make cash withdrawals, credit card cash advances, and check their account balances as well as perform other banking tasks.

Most ATMs are connected to interbank networks, enabling people to withdraw and deposit money from machines not belonging to the bank where they have their account or in the country where their accounts are held (enabling cash withdrawals in local currency). Some examples of interbank networks include PULSE, PLUS, Cirrus, Interac, Interswitch, STAR, and LINK.

ATMs rely on authorization of a financial transaction by the card issuer or other authorizing institution via the communications network. This is often performed through an ISO 8583 messaging system.

ATMs typically connect directly to their host or ATM Controller via either ADSL or dial-up modem over a telephone line or directly via a leased line. Leased lines are preferable to POTS lines (plain old telephone service) because they require less time to establish a connection. Leased lines may be comparatively expensive to operate versus a POTS line, meaning less-trafficked machines will usually rely on a dial-up modem. That dilemma may be solved as high-speed Internet Virtual Private Network (VPN) connections become more ubiquitous. Common lower-level layer communication protocols used by ATMs to communicate back to the bank include Systems Network Architecture (SNA) over Synchronous Data Link Control (SDLC), and TCP/IP over Ethernet.

In addition to methods employed for transaction security and secrecy, all communications traffic between the ATM and the Transaction Processor may also be encrypted via methods such as SSL (Secure Sockets Layer).

An ATM is typically made up of the following devices:
CPU (to control the user interface and transaction devices)
Magnetic and/or Chip card reader (to identify the customer)
PIN Pad (similar in layout to a Touch Tone or calculator style keypad), often manufactured as part of a secure enclosure.
Secure cryptoprocessor, generally within a secure enclosure.
Display (used by the customer for performing the transaction)
Function key buttons (usually close to the display) or a Touchscreen (used to select the various aspects of the transaction)
Record Printer (to provide the customer with a record of their transaction)
Vault (to store the parts of the machinery requiring restricted access)
Housing (for aesthetics and the attachment of signage)

Due to heavier computing demands and the falling price of computer-like architectures, ATMs are moving away from custom hardware architectures using microcontrollers and/or application-specific integrated circuits to adopting the hardware architecture of a personal computer, such as USB connections for peripherals, Ethernet and IP communications, and may use personal computer operating systems.

A router is a device that forwards data packets between computer networks, creating an overlay internetwork. A router can be connected to one or more destinations from different networks. When a data packet comes in from one of the connections, the router reads the address information in the packet to determine its ultimate destination. Then, using information in its routing table or routing policy, it directs the packet to the next network on its journey. Routers perform the “traffic directing” functions on the Internet. A data packet is typically forwarded from one router to another through the networks that constitute the internetwork until it gets to its destination node.

The most familiar type of routers are home and small office routers that simply pass data, such as web pages and email, between the home computers and the owner's cable or DSL modem, which connects to the Internet (ISP). However more sophisticated routers range from enterprise routers, which connect large business or ISP networks up to the powerful core routers that forward data at high speed along the optical fiber lines of the Internet backbone.

In the past, ATMs typically had a single communications link with a single host computer system. If that single communications link or host computer system failed, the ATM was effectively disabled. Restoring the link often involved rebooting the ATM's internal operating system or manually rerouting the ATM traffic via telco carriers or manually changing the ATM's single destination IP address, further extending the time the ATM was unavailable to cardholders

In an effort to address this problem, some ATM operators have connected a more expensive external router to allow support of multiple routing tables for multiple communications destinations for the ATM. In addition to possible security issues and added cost, an external router is not responsive to the state of the ATM. As a result, an external router may attempt to switch the connection from an alternative host back to a restored connection to the primary host when the ATM is in the middle of a transaction. This can have unintended consequences. In addition, it also increases the cost of maintaining the infrastructure of the routers, routing tables and management of access list for supporting rerouting of the ATM traffic. In addition, communications between the ATM and the external router is not typically encrypted due to the complex nature of such encryption methods available. This present invention solves these problems.

### BRIEF SUMMARY OF THE INVENTION

An Automatic Teller Machine (ATM) comprises a router responsive to the state of the ATM. In certain embodiments, the router may be a software router. The router may preferentially connect the ATM system to a primary host but has the ability to connect to one or more alternative host systems. If a connection to the primary host cannot be established (or the connection to the primary host is lost), the router automatically establishes a connection to an alternative host. In one particular preferred embodiment, the router waits to switch a connection from an alternative host back to the primary host until the ATM has completed any pending transactions. In addition the integral router optionally has the ability to encrypt sensitive data before it is forwarded outside of the ATM.

### BRIEF DESCRIPTION OF THE SEVERAL VIEWS OF THE DRAWING(S)

FIG. 1A is a schematic diagram of an ATM with an integral router according to a first embodiment of the invention with network data connections to a plurality of host servers.

FIG. 1B is a schematic diagram of an ATM with an external router according to a second embodiment of the invention with network data connections to a plurality of host servers.

FIG. 2 is a flow diagram of a message routing method according to one embodiment of the invention.

FIG. 3 is a flow diagram of a connection establishing and monitoring routine according to one embodiment of the invention.

FIG. 4 is an alternative flowchart representation of a method according to the invention.

### DETAILED DESCRIPTION OF THE INVENTION

The invention may best be understood by reference to the exemplary embodiment(s) illustrated in the drawing figures.

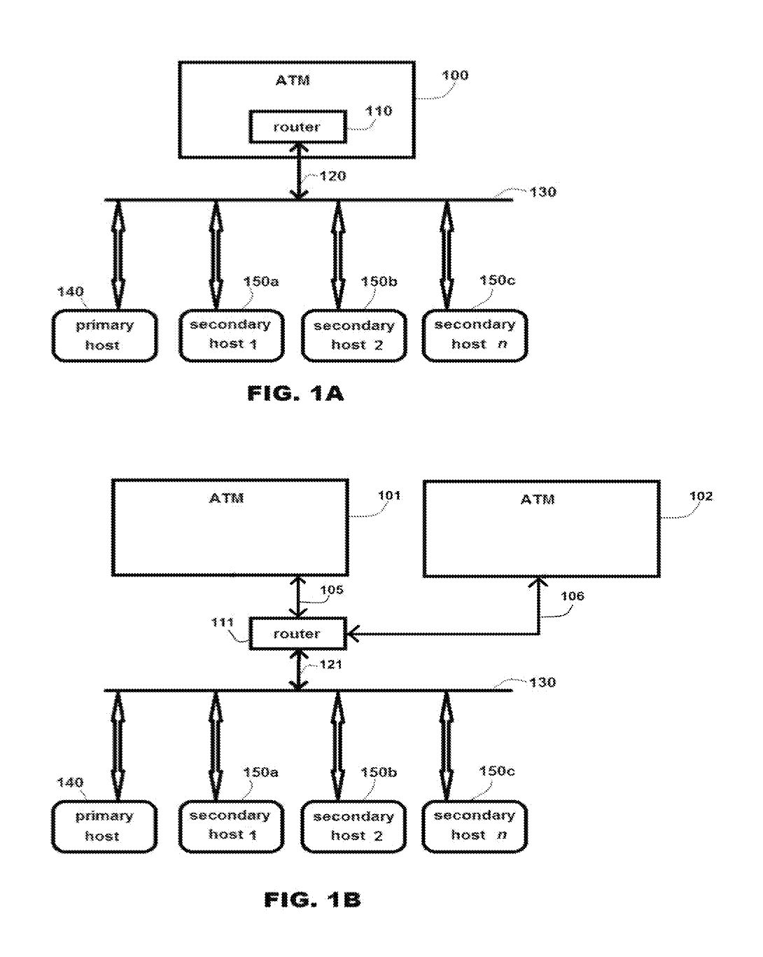

FIG. 1A illustrates a representative system according to one particular embodiment of the invention. ATM 100 is equipped with integrated router 110 which allows data communication to a primary host 140 and one or more alternative hosts 150a, 150b and 150c via a data connection 120 to a network 130 which may, for example, be a private LAN, a wide area network (WAN) or the Internet.

FIG. 1B illustrates a representative system according to another embodiment of the invention. ATMs 101 and 102 are connected via data channels 105 and 106, respectively, to non-integral router 111 which allows data communication between each ATM and a primary host 140 and one or more alternative hosts 150a, 150b and/or 150c via a data connection 121 to a network 130 which may, for example, be a private LAN, a wide area network (WAN) or the Internet. It will be appreciated that non-integral router 111 may be connected to only a single ATM and be configured to route messages to and from a host system (primary or secondary) and the ATM. In yet other embodiments, router 111 may be connected to a plurality of ATMs 101 each of which may have its own designated set of primary and secondary hosts.

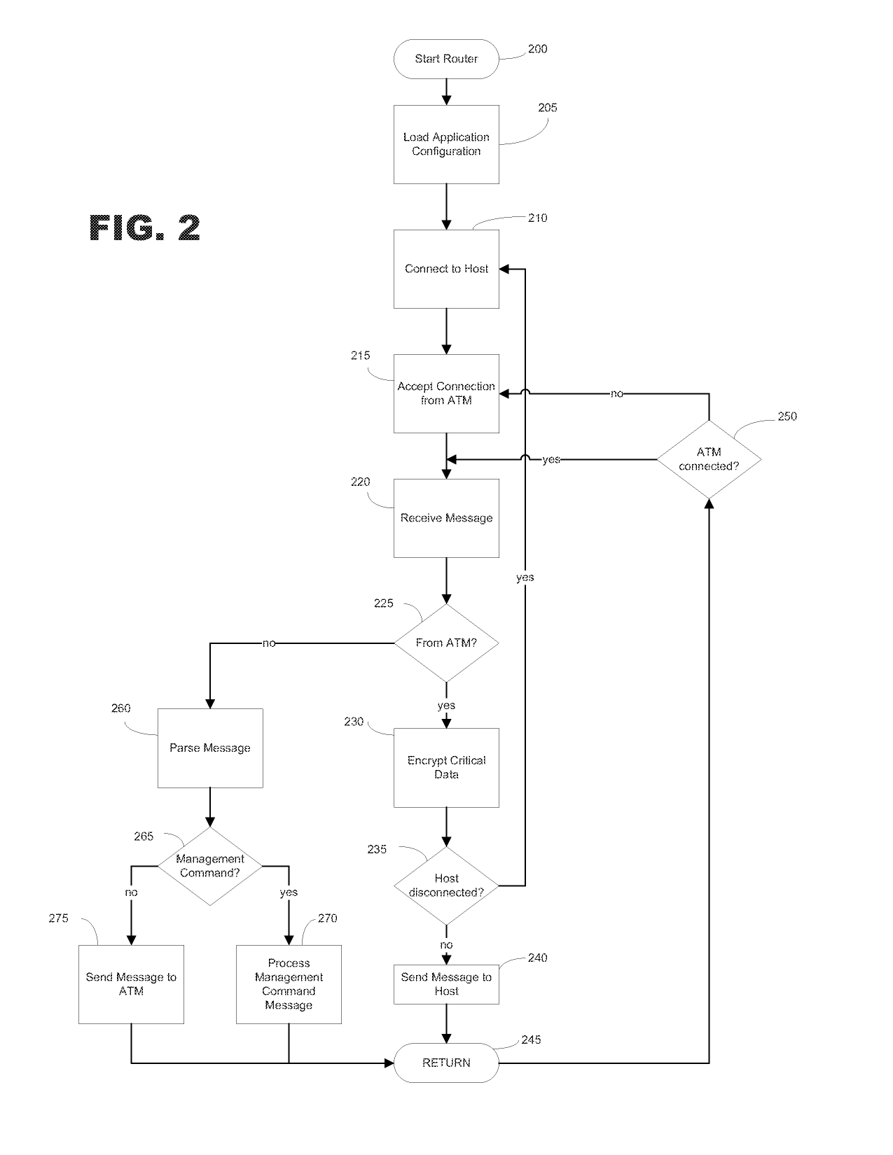

The flowchart of FIG. 2 conceptually shows how an ATM according to the invention may connect to a host and send and receive messages (data) to and from a host system.

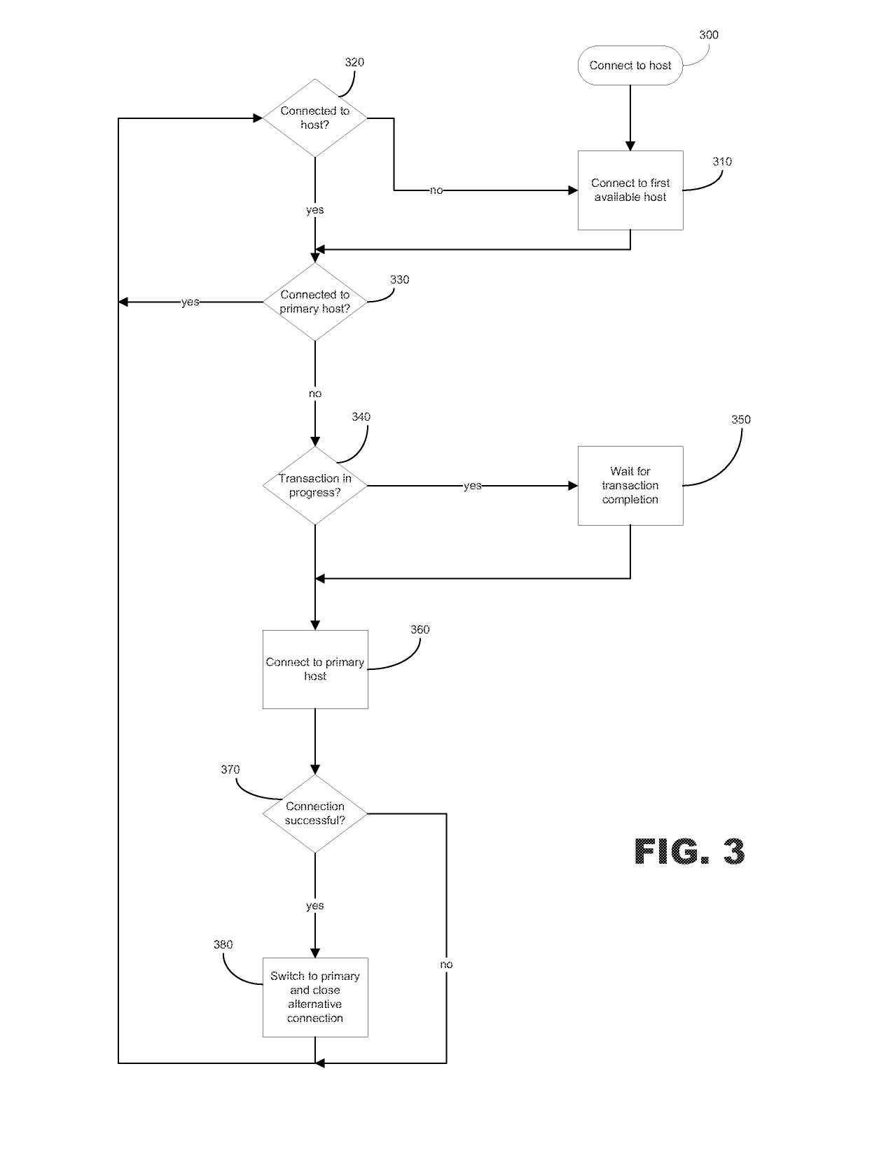

The process may begin the initialization 200 of the integrated router (110 in FIG. 1A) and the loading 205 of the particular application configuration which may include available host and associated IP addresses, timer and various miscellaneous configuration setting. The router may then establish a connection to a host system at block 210. One particular host connection process is shown in the flowchart of FIG. 3 which may be a subroutine or parallel process.

Meanwhile, the ATM may be attempting to establish a connection with the router and, at block 215, the router may accept the connection from the ATM.

With the data connections established, the router may proceed to receive messages (at block 220) which may be in the form of data packets according to an established protocol—e.g., TCP/IP.

At decision diamond 225, the router may determine whether a received message is from the ATM. The information necessary for that determination is evident from the particular receiving channel.

As shown by the “yes” branch of diamond 225, if the received message is from the ATM, integral router 110 may proceed to encrypt all or a portion of the data at block 230. If the host system has not disconnected (“no” branch at diamond 235) the router may proceed as shown at block 240 to send the (encrypted) message to the host system and return (at 245) to its idle state wherein the connection to the ATM may be tested (at decision diamond 250). If the router is no longer connected to the ATM (“no” branch at 250) the router may return to state 215 and accept a connection from the ATM. If, on the other hand, the ATM is still connected to the router (“yes” branch at 250) the router may return to state 220 and wait to receive another message.

If a message received by the router is not from the ATM (“no” branch at diamond 225), the message must be from the host system. In the illustrated embodiment, a message from the host system may be one of two types—a message to the ATM or a management command for the router.

An incoming message from the host system may be parsed at block 260 to determine its type. If it is a management command (“yes” branch at 265), the command may be processed at block 270 and the router may then return to its idle state at 245 awaiting the receipt of additional messages. If the parsed message is determined not to be a management command (“no” branch at 265), the message may be sent at block 275 to the ATM.

FIG. 3 shows a parallel process which effects connection to a host system (primary or alternative) and automatically re-establishes the connection to the primary host if a connection to an alternative host has been employed. This process may be initiated 300 from block 210 in the method depicted in the flowchart of FIG. 2. As shown at block 310, integrated router 110 (FIG. 1A) may initially connect to the first available host system. In some embodiments, the possible host systems may be prioritized such that the router first attempts to connect to the primary host system (140 in FIG. 1A) before connecting to a secondary host system (150 in FIG. 1A).

At decision diamond 330, a determination is made as to whether the connection is to the primary host. If so (“yes” branch at 330), the process continues to monitor the connection (at block 320) and returns to the connection set up process at block 310 if the host connection is broken (“no” branch at 320).

If it is determined (at 330) that the router's connection is not to the primary host, but rather to a secondary host (“no” branch at 330), the system may determine (at 340) whether an ATM transaction is in progress. It has been found that system performance is improved if switching the ATM from a functioning secondary host to a restored connection with the primary host is delayed until a transaction is not in progress. This is illustrated in FIG. 3 as the “yes” branch at 340. In that event, the system waits (at block 350) until the current ATM transaction has been completed before switching the ATM host connection back to the primary host.

This process is illustrated in FIG. 3 as connecting to the primary host (at block 360), determining whether the connection to the primary host is fully functional (diamond 370), switching to the primary host and closing the connection to the secondary host (at block 380). At this point, the system may return to monitoring the connection as shown at diamond 320.

If, for any reason, the attempt to establish a connection to the primary host is unsuccessful (“no” branch at 370), the system may return to monitoring the previously-established connection to a secondary host (at 320) while also attempting to reconnect with the primary host (at block 360).

For the purpose of illustration clarity, this process has been diagramed in FIG. 3 as sequential steps. Those skilled in the art will appreciate that the computer systems commonly employed in ATMs are capable of multitasking and/or running programs with multiple threads. In such a system, the connection to the primary host (shown as block 360 in FIG. 3) need not be delayed (at 350) until a present ATM transaction is completed but rather may proceed in parallel—i.e., the router may attempt to establish a “silent” connection to the primary host while the connection to a secondary host is still in use or delay attempting to switch the ATM connection back to the primary host until any pending ATM transactions have been completed.

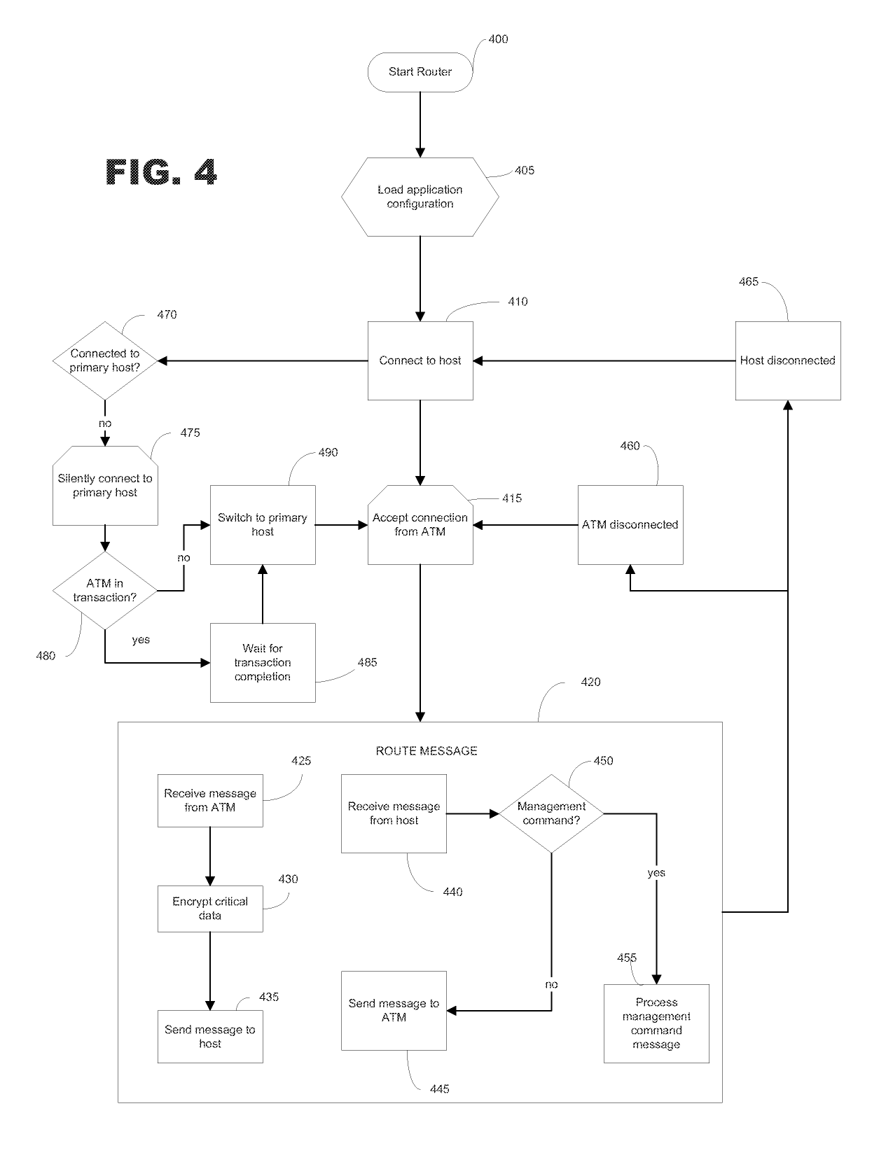

FIG. 4 is an alternative representation of the method of the invention showing how an ATM according to one embodiment of the invention may continuously monitor its connection status and change the connection to a particular host at an opportune time.

The process of starting and initializing the integral router 110 (or 111) begins at 400 and includes loading of the router's application configuration (at 405). At block 410, the router connects to a host system (140, 150a, 150b or 150c in FIG. 1A). In certain embodiments, the router may connect to the first available host system. In other embodiments, the host systems may be prioritized and the router may first attempt to connect to a designated primary host (140 in FIG. 1A) and only attempt to connect to a secondary host (150 in FIG. 1A) if a connection to the primary host cannot be timely achieved.

At block 415, the router also makes a connection to the ATM (100 in FIG. 1A or 101 in FIG. 1B) and, after both connections are established, the router may proceed to route messages. This function is shown generally within box 420 of FIG. 4. If the router receives a message from ATM 100 (block 425), integral router 110 may optionally encrypt the critical data (block 430) and then send the (encrypted) message to the host system to which it is connected (as shown at block 435). In a system having a non-integral router (such as router 111 in FIG. 1B), the message may be encrypted at the ATM (e.g., using IPSec or equivalent), then decrypted at the external router 111. Once router 111 determines what it needs, it may encrypt only the sensitive data in the message before passing it on. At the conclusion of this process, the router may return to its idle state awaiting another incoming message.

If, as shown at block 440, the router receives a message from the host system, the message may be tested (at diamond 450) to determine whether the message comprises a management command such as changing a miscellaneous configuration setting, timer, adding new host destinations and their IP addresses or request a router log upload to the host. If so (“yes” branch at 450), the router may process the management command (block 455) and then return to its idle state. If the incoming message is not a management command (“no” branch at 450), the router may proceed (as shown at block 445) to send the message to ATM 100 (or 101). After routing the message to the ATM, router 110 (or 111) may return to an idle state awaiting the receipt of another incoming message.

The process shown in FIG. 4 has multiple threads which may operate substantially simultaneously. Block 460 is one such thread which monitors the router's connection to the ATM and, if that connection is broken, re-activates the process shown at 415 wherein the router may accept a connection from the ATM. Similarly, block 465 represents a process which monitors the connection of the router to the host system and re-activates the connection process shown at block 410 in the event that the connection to the host is lost.

Elements 470 through 490 in FIG. 4 illustrate a concurrent process that may re-connect the router to the ATM's primary host if a secondary host (150 in FIG. 1A) is being used. At 470, the ATM's connection to the host system is tested to determine whether the host is the designated primary host (140 in FIG. 1A). If so, no further action is required and the monitoring may continue. However, if there is no connection to the primary host (“no” path at 470), the router may establish a “silent connection” to the primary host. In this context, a “silent connection” is one in which no ATM downtime is perceived by the host system or ATM. A connection to one available host computer system is maintained until another is available and this transition occurs between events such that is it is not noticeable.

As shown at diamond 480, after connecting to primary host 140, router 110 (or 111) may determine whether ATM 100 (or 101) is actively involved in a transaction. In certain preferred embodiments of the invention, this may be accomplished by router 110 (or 111) examining the messages passing through it. Typically, each ATM transaction starts with a particular type of message and ends with another particular type of message. Thus, certain pairs of message types can be used to determine whether a transaction is in progress. If the ATM (100 or 101) is not actively involved in a transaction (“no” branch at 480), router 110 (or 111) may proceed to switch its host connection to primary host 140 (block 490) and, if necessary, accept a connection from the ATM (block 415) before routing messages (box 420). If, however, the ATM is processing a transaction (“yes” branch at 480), router 110 (or 111) may wait for that transaction to be completed (at block 485) before switching the host connection to the primary host (block 490). In certain embodiments, the wait period may be determined by retesting the status of the ATM (as shown at diamond 480) until that status is found to be “idle” or another state which does not require data communications with the host system.

Although the invention has been described in detail with reference to certain preferred embodiments, variations and modifications exist within the scope and spirit of the invention as described and defined in the following claims.

What is claimed is:

1. A method for routing data to or from an automated teller machine comprising:
establishing a data connection to the first available host system in a predetermined set of host systems that is comprised of a primary host and at least one alternative host;
determining whether the connection is to the primary host or an alternative host;
determining whether the automated teller machine is processing a transaction if the connection is to an alternative host;
waiting until any active transactions of the automated teller machine are completed; and
then switching the connection from the alternative host to the primary host if the connection was determined to be to an alternative host.

2. A method as recited in claim 1 wherein establishing a data connection to the first available host system comprises attempting to connect to the primary host system before attempting to connect to an alternative host system.

3. A method as recited in claim 2 wherein a plurality of alternative host systems are each assigned a priority and connection attempts are made in the order of the host system's priority.

4. A method as recited in claim 1 further comprising accepting a connection from the automated teller machine.

5. A method as recited in claim 1 further comprising monitoring a connection to a host system and repeating the process if the connection is interrupted.

6. A method as recited in claim 5 wherein the monitoring is performed substantially simultaneously with routing data to and from the automated teller machine.

7. A method as recited in claim 4 further comprising monitoring the connection from the automated teller machine and accepting a new connection from the automated teller machine if the connection is interrupted.

8. A method as recited in claim 7 wherein the monitoring is performed substantially simultaneously with routing data to and from the automated teller machine.

9. A method as recited in claim 1 further comprising attempting a second, silent connection to the primary host while maintaining the connection to the secondary host if the connection is determined to be to a secondary host.

10. An automated teller machine comprising a processor-controlled router and a memory storing instructions for causing the router to:
establish a data connection to the first available host system in a predetermined set of host systems that is comprised of a primary host and at least one alternative host;
determine whether the connection is to the primary host or an alternative host;
determine whether the automated teller machine is processing a transaction if the connection is to an alternative host;
wait until any active transactions of the automated teller machine are completed; and
then switch the connection from the alternative host to the primary host if the connection was determined to be to an alternative host.

11. An automated teller machine as recited in claim 10 wherein the instruction to establish a data connection to the first available host system comprises an instruction to connect to the primary host system before attempting to connect to an alternative host system.

12. An automated teller machine as recited in claim 11 wherein a plurality of alternative host systems are each assigned a priority and connection attempts are made in the order of the host system's priority.

13. An automated teller machine as recited in claim 10 further comprising an instruction to accept a connection from the automated teller machine.

14. An automated teller machine as recited in claim 10 further comprising instructions to monitor a connection to a host system and to repeat the process if the connection is interrupted.

15. An automated teller machine as recited in claim 14 wherein the monitoring is performed substantially simultaneously with routing data to and from the automated teller machine.

16. An automated teller machine as recited in claim 13 further comprising instructions to monitor the connection from the automated teller machine and to accept a new connection from the automated teller machine if the connection is interrupted.

17. An automated teller machine as recited in claim 16 wherein the monitoring is performed substantially simultaneously with routing data to and from the automated teller machine.

18. An automated teller machine as recited in claim 10 further comprising instructions to attempt a second, silent connection to the primary host while maintaining the connection to the secondary host if the connection is determined to be to a secondary host.

19. A computer-readable medium comprising instructions for connecting an automated teller machine to a host system by performing the steps of:
establishing a data connection to the first available host system in a predetermined set of host systems that is comprised of a primary host and at least one alternative host;
determining whether the connection is to the primary host or an alternative host;
determining whether the automated teller machine is processing a transaction if the connection is to an alternative host;
waiting until any active transactions of the automated teller machine are completed; and
then switching the connection from the alternative host to the primary host if the connection was determined to be to an alternative host.

20. A computer-readable medium as recited in claim 19 further comprising instructions for attempting a second, silent connection to the primary host while maintaining the connection to the secondary host if the connection is determined to be to a secondary host.

21. A processor-controlled router having means for connecting to one or more automated teller machines and comprising a memory storing instructions for causing the router to:
establish a data connection to the first available host system in a predetermined set of host systems that is comprised of a primary host and at least one alternative host;
determine whether the connection is to the primary host or an alternative host;
determine whether an automated teller machine in data communication with the router is processing a transaction if the connection is to an alternative host;
wait until any active transactions of the automated teller machine are completed; and
then switch the connection from the alternative host to the primary host if the connection was determined to be to an alternative host.

22. A router as recited in claim 21 wherein the instruction to establish a data connection to the first available host system comprises an instruction to connect to the primary host system before attempting to connect to an alternative host system.

23. A router as recited in claim 22 wherein a plurality of alternative host systems are each assigned a priority and connection attempts are made in the order of the host system's priority.

24. A router as recited in claim 21 further comprising an instruction to accept a connection from the automated teller machine.

25. A router as recited in claim 21 further comprising instructions to monitor a connection to a host system and to repeat the process if the connection is interrupted.

26. A router as recited in claim 25 wherein the monitoring is performed substantially simultaneously with routing data to and from the automated teller machine.

27. A router as recited in claim 24 further comprising instructions to monitor the connection from the automated teller machine and to accept a new connection from the automated teller machine if the connection is interrupted.

28. A router as recited in claim 27 wherein the monitoring is performed substantially simultaneously with routing data to and from the automated teller machine.

29. A router as recited in claim 21 further comprising instructions to attempt a second, silent connection to the primary host while maintaining the connection to the secondary host if the connection is determined to be to a secondary host.

30. A router as recited in claim 21 wherein the router is a software router that is integral with an automated teller machine.
